(19) United States
(12) Patent Application Publication
(10) Pub. No.: US 2009/0302619 A1
(43) Pub. Date: Dec. 10, 2009

(54) Magnetic Lock Means With Auxiliary Mechanical Locking or Resistance Means

(76) Inventor: Jason Chang, Fengxian (CN)

Correspondence Address: PROCOPIO, CORY, HARGREAVES & SAVITCH LLP, 530 B STREET, SUITE 2100, SAN DIEGO, CA, 92101, US

(21) Appl. No.: 12/374,029

(22) PCT Filed: Jul. 19, 2007
(86) PCT No.: PCT/AU2007/001003

§ 371 Date: Jul. 21, 2009

(30) Foreign Application Priority Data
Jul. 20, 2006 (AU) 2006903924
Aug. 29, 2006 (AU) 2006904705

(51) Int. Cl. E05C 19/16

(52) U.S. Cl. 292/251.5

(57) ABSTRACT

A lock is disclosed including magnetic and mechanical locking features. The mechanical lock means operates in response to an attempt to force open the lock. The mechanical lock means includes a pin and at least one locking element; the mechanical lock means operates by engagement of the at least one locking element with a recess.

### TECHNICAL FIELD

This invention relates to a lock such as might be used to retain a door in an open or closed position.

### BACKGROUND TO THE INVENTION

Locks are commonly used to retain doors or windows or the like in either an open or closed condition. In the case where it is desirable control the lock from a remote location, an electrically operated lock may be used. One form of electrically operated lock is an electromagnetic lock. These typically comprise an armature of ferrous material and an electromagnet. Activation of the electromagnet causes strong magnetic attraction between the armature and electromagnet. It is necessary for current to flow through the electromagnet to maintain the attraction. Deactivation of the electromagnet allows the armature to release from the electromagnet.

In the case of security doors in commercial premises or the like, electromagnetic locks are sometimes used which require a force of about 2000N to 5000N to break the attraction between the armature and the electromagnet. In order to provide such strong magnetic attraction it is necessary to use a strong electromagnet and a correspondingly large armature. In addition, a current of approximately between 40 mA up to 400 mA must constantly flow through the electromagnet whilst it is retaining the door.

The following formula shows the general equation determining the electromagnet holding force:

F=K*(B_{g})²*A

### Where

F is the holding force in Newton,

K is the constant,

B_{g} is full density of magnetism (Wbm²)

A is the surface area of the electromagnet (m²)

It would be advantageous to provide a remotely operable lock with an adequately strong locking action which uses either a smaller amount of raw materials during construction or which uses less electricity during operation than existing locks.

### SUMMARY OF THE INVENTION

The present invention provides a lock including magnetic lock means and mechanical lock means.

### BRIEF DESCRIPTION OF THE DRAWINGS

An embodiment of the present invention will now be described, by way of example only, with reference to the accompanying drawings, in which:

FIG. 1 is a cross sectional view along the line A-A of FIG. 2 of a lock according to an embodiment of the present invention;

FIG. 2 is a cross sectional view of the lock of FIG. 1 along the line C-C;

FIG. 3 is a cross sectional view of the lock of FIG. 2, but in a position when a force is being exerted upon the door being locked;

FIG. 4 is a cross section view of the lock of FIG. 2 along the line B-B and shown affixed to a door in a position when a force is being exerted upon the door;

FIG. 5 shows the lock in the same view as shown in FIG. 4, but in the position shown in FIG. 3;

FIG. 6 shows an enlarged perspective view of the sleeve of the lock of FIG. 1′

FIG. 7(a) shows a lock according to a second embodiment of the invention;

FIG. 7(b) shows the lock of FIG. 7(a) in another position; and

FIG. 7(c) shows the lock of FIG. 7(a) in yet another position.

### DETAILED DESCRIPTION OF THE PREFERRED EMBODIMENT

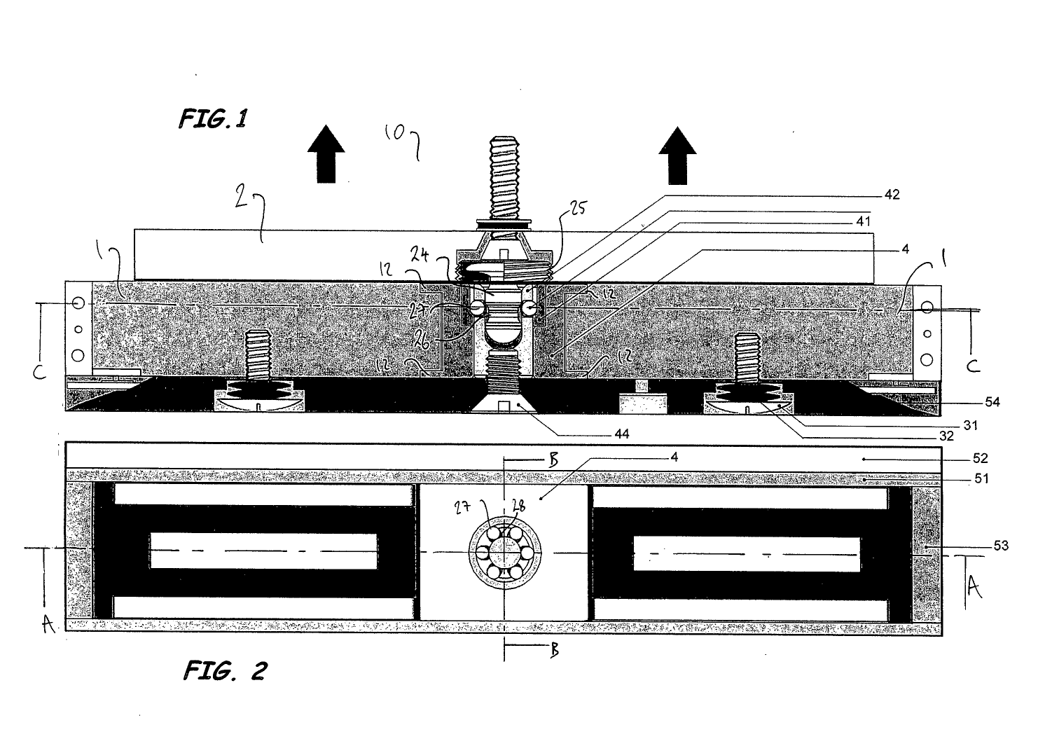

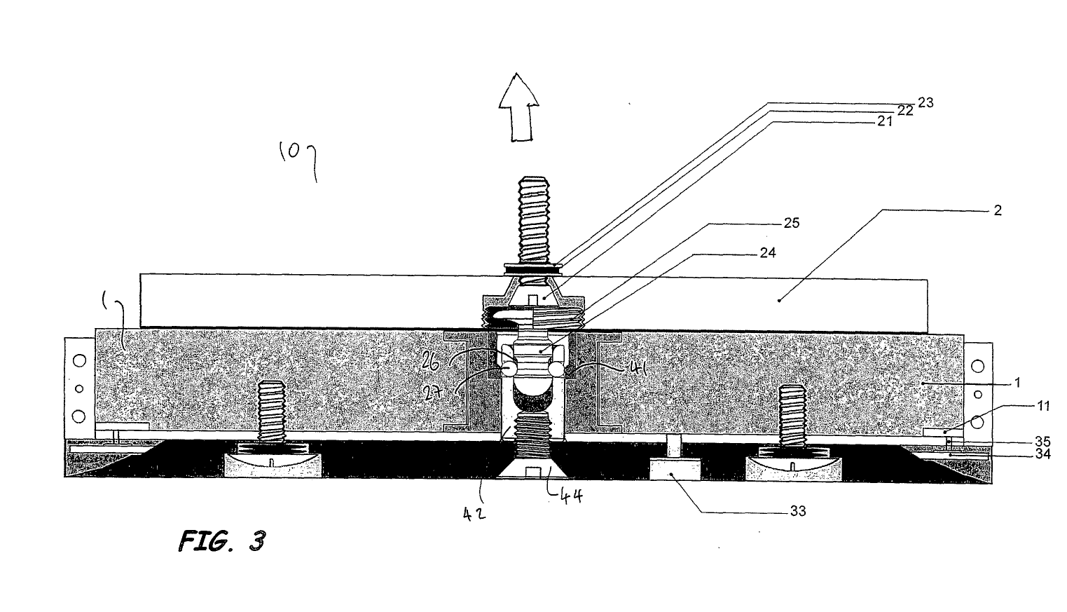

Referring to FIG. 1, a lock 10 is shown including magnetic lock means in the form of two electromagnets 1 which, when supplied with electric current, are magnetically attracted to armature 2.

Lock 10 further includes mechanical lock means including pin 24 which has a groove 26 provided about its shaft. Pin 24 is attached to armature by way of screw thread 25.

A hollow sleeve 42 is affixed to backing plate 54 by way of screw 44 and surrounds pin 24. Six locking elements in the form of generally spherical balls 27 are mounted in sleeve 42. Each ball 27 sits in a through hole 28 in sleeve 42. Each through hole 28 narrows slightly at the end nearest the centre of the sleeve. This allows each ball 27 to be inserted into hole 28 from the outside of the sleeve, and each ball is prevented from passing right through the hole 28 by the narrowed portion.

The electromagnets 1 are connected to a centre piece 4 which carries a shoulder 41. Electromagnets 1 are mounted to backing plate 54 by way of screws 31 packed with a stack of sprung washers 32. Centre piece 4 sits between electromagnets 1 and is maintained in a substantially fixed relationship to the electromagnets by way of flanges 12. Sprung electrical contact fingers 35 bear against flat contacts 11 to provide electrical connections to the electromagnets 1.

When electric current is supplied to electromagnets 1 they become attracted to armature 2. An attempt to open the door whilst the electromagnets are active causes movement of armature 2 along with electromagnets 1 and centre piece 4 in the direction indicated by the bold arrows in FIG. 1 by way of compression of sprung washers 32 (note compression of washers 32 in FIG. 3). The electromagnets 1, centrepiece 4 and shoulder 41 move as one to the position shown in FIG. 3. The sleeve 42 remains fixed to backing plate 54.

Comparing FIGS. 1 and 3, in FIG. 1 balls 27 are out of engagement with groove 26. However, in FIG. 3, movement of shoulder 41 has effected a ramping movement which has guided balls 27 into engagement with groove 26. Thereafter, increased force applied to the armature in the direction shown by the white arrow in an attempt to open the door is resisted by engagement of balls 27 within groove 26 of pin 24. Thus, in FIG. 3 both the magnetic action of electromagnets 1 and the physical engagement of balls 27 and pin 26 simultaneously serve to resist separation of the armature from the electromagnets and thus keep the door closed.

It has been found that, when compared to locks that rely on electromagnetic attraction alone, locks according to embodiments of the invention can provide the same resistance to opening but use electromagnets of reduced capacity. This means it is possible to use smaller electromagnets and thus use less raw materials to achieve the same strength of lock as in the case of known electromagnetic locks, with a consequential drop in power consumption due to the reduced capacity of the electromagnet.

Microswitch 33 is configured to detect movement of the electromagnets 1 between the positions shown in FIGS. 1 and 3. This allows remote detection of a force being applied to a door that is sufficient to compress sprung washers 32 and may indicate an attempt to force open the door.

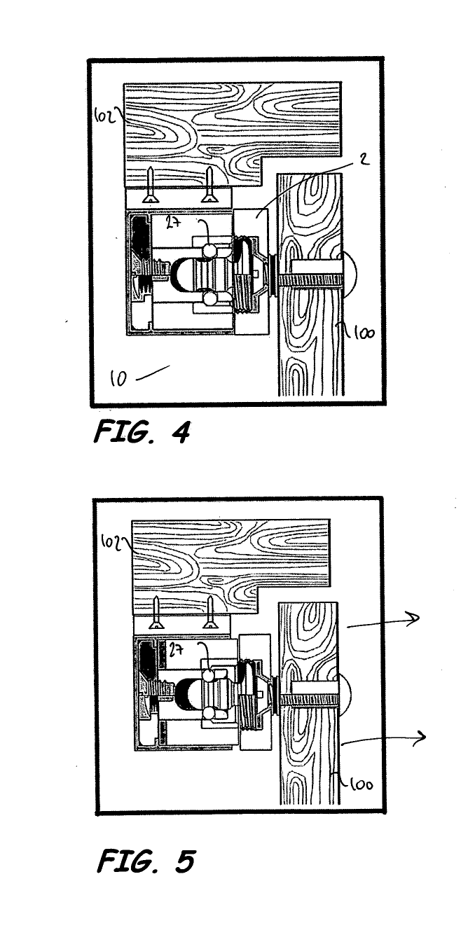

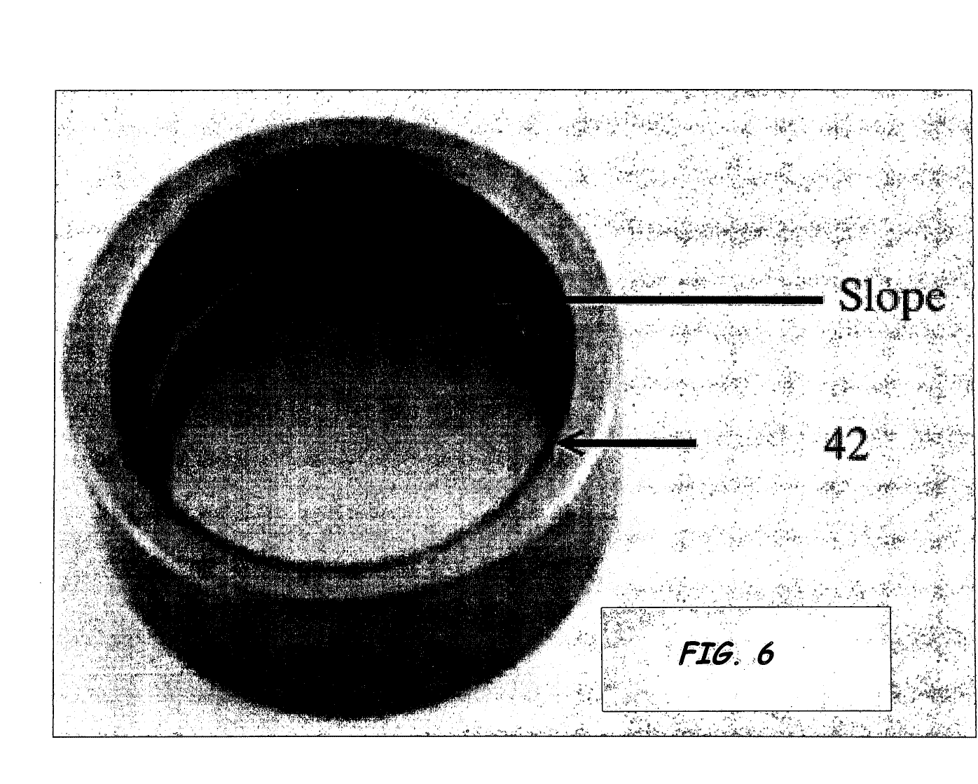

Comparing FIGS. 4 and 5, the lock is shown at rest in FIG. 4 with the lock affixed to doorjamb 102 and armature 2 affixed to door 100. At FIG. 5 the lock is shown when a forced attempt is being made to open the door 100. Note that in FIG. 5, balls 27 have been pushed into engagement with groove 26 of pin thus providing mechanical resistance to separation of armature and electromagnets.

Referring again to FIG. 1, when the electromagnets deactivated there is no attraction between the armature 2 and the electromagnets 1. Thus, if an attempt it made to open the door, the armature easily separates from the electromagnets. Pin 24 is free to release from sleeve 42 as balls 27 are not held in engagement with groove 26 by shoulder 41.

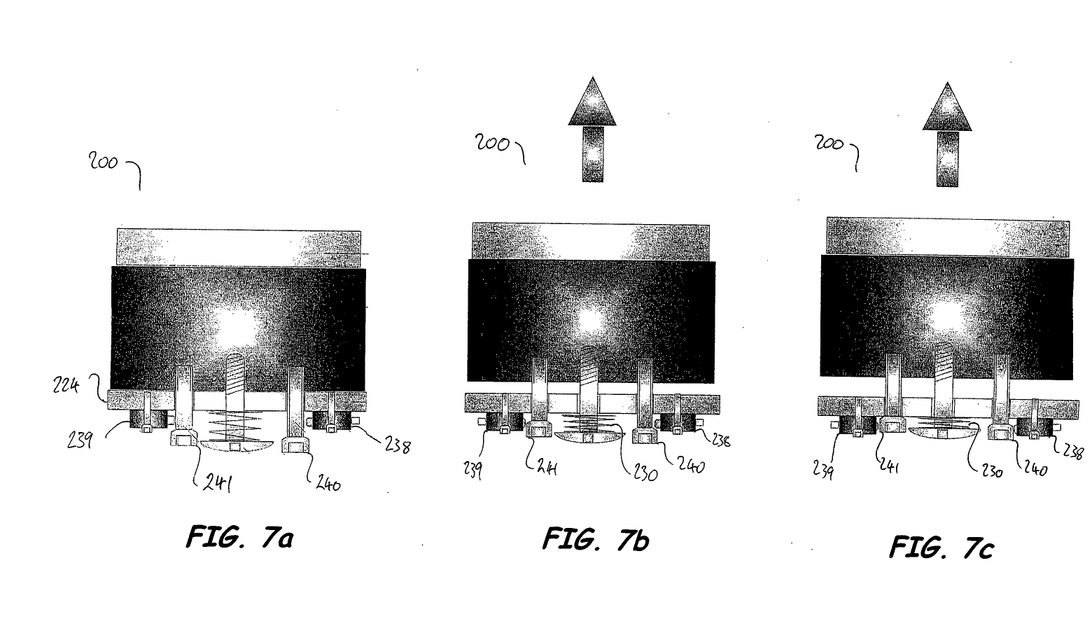

Referring to FIG. 7(a), an alternative embodiment of the invention is shown. In this version two microswitches 238,239 are used. The microswitches are actuated by the heads of actuation screws 240, 241. The depth of insertion of each of screws 241, 240 into plate 224 dictates the force required to actuate either of microswitches 239, 240.

Referring to FIG. 7(b), a moderate force is being applied to device 200 which is comparable to the force that might be applied by a person attempting to push open a door. The force is balanced by compression of spring 230. It can be seen that microswitch 239 has become actuated by the head of actuation screw 241.

Referring to FIG. 7(c), a large force is being applied to device 200 which is comparable to the force that might be applied by a person attempting to force open a door. The force is balanced by further compression of spring 230. It can be seen that microswitch 238 has become actuated by the head of actuation screw 240.

Device 200 includes a radio transmitter device which can transmit signals indicating a condition of device 200 based on the positions of microswitches 239, 240. If neither switch is actuated then this indicates that the door is not being pushed.

If switch 239 is actuated then this indicates that somebody may be attempting to open the door. The radio transmitter circuit may transmit a signal indicating this. This may be received at a local unit which sounds an alarm to indicate to the person that the door is locked.

If switches 239 and 240 are actuated then this indicates that somebody may be making a forced attempt to break open the door. The radio transmitter circuit may transmit a signal indicating this. This may be received at a remote security console or the like to indicate to security personnel that a forced attempt may be being made to open the door to which device 200 is attached.

In the above described embodiment the lock was described as being used to retain a door in the closed position. Similarly, the lock can be used with windows and other building openings. Similarly, the lock can be used to keep a door or window or the like in the open position.

The lock described above utilised two electromagnets. Similarly, a greater or lesser number of electromagnets can be used.

The lock described above utilised one pin which provided a mechanical locking action. Similarly, more than one pin can be used.

The lock described above included electromagnets that were connected to their power supply by way of sprung finger contacts provided on the backing plate of the lock which made contact with terminals of the electromagnets when the electromagnets were installed in the lock. Similarly, the electromagnets could be hard wired.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A lock including:
magnetic lock means; and
mechanical lock means;
the mechanical lock means includes a pin and at least one locking element;
the pin includes a recess;
the mechanical lock means operates by engagement of the at least one locking element with the recess; and
wherein the mechanical lock means operates in response to an attempt to force open the lock.

2. A lock according to claim 1 wherein the recess is in the form of a groove provided about the shaft of the pin.

3. A lock according to either of claim 1 or claim 1 wherein the lock includes a plurality of locking elements which are generally spherical.

4. A lock according to any preceding claim further including a shoulder associated with the magnetic lock means and wherein movement of the shoulder causes engagement of the at least one locking element with the recess.

5. A lock according to claim 4 wherein the shoulder is generally circular and surrounds the pin.

6. A lock according to any preceding claim wherein the at least one locking element is mounted in a sleeve which surrounds the pin.
